(19) United States
(12) Patent Application Publication
(10) Pub. No.: US 2010/0140148 A1
(43) Pub. Date: Jun. 10, 2010

(54) PAPER SHEET HANDLING MACHINE

(76) Inventors: Shinji Matsuura, Tokyo-to (JP); Hajime Morino, Saitama-ken (JP)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 12/733,236

(22) PCT Filed: Aug. 30, 2007
(86) PCT No.: PCT/JP2007/066919

§ 371 Date: Feb. 16, 2010

(51) Int. Cl. B07C 5/34; B65H 7/02; B65H 39/02; B65H 43/00

(52) U.S. Cl. 209/534; 271/4.03; 271/302; 271/176

(57) ABSTRACT

A paper sheet handling machine has a taking-in unit that takes in paper sheets one by one, a transport state detection unit that detects a transport state of each of the paper sheets taken in by the taking-in unit, a transport unit that transports the paper sheets taken in by the taking-in unit, a recognition unit that recognizes kinds of the paper sheets transported by the transport unit, first and second stacking units that have stackers to stack the paper sheets transported by the transport unit, respectively, and a control unit that judges abnormally transported paper sheets according to a detection result of the transport state detection unit, judges specific normal paper sheets, specific abnormal paper sheets or non-specific paper sheets according to a recognition result of the recognition unit, and controls the transport unit to transport the paper sheets judged as the specific abnormal paper sheets or the non-specific paper sheets to the first stacking unit and transport the paper sheets judged as the abnormally transported paper sheets or the specific normal paper sheets to the second stacking unit.

### BACKGROUND OF THE INVENTION

1. Field of the Invention

The present invention relates to a paper sheet handling machine. In particular, the invention relates to a paper sheet handling machine that can sort specific paper sheets (for example, (US dollar banknotes) to be previously defined as process objects into normal paper sheets and abnormal paper sheets, and also sort paper sheets (for example, barcoded vouchers and JP banknotes) other than the specific paper sheets.

2. Related Art

In recent years, among stores that deal with paper sheets, such as banknotes, the number of stores that equally handle the banknotes and the paper sheets other than the banknotes has increased. For example, in casinos, coinless slot machines are disposed, and only the banknotes and barcoded vouchers are used. In these stores, a sorting job of the paper sheets where the banknotes and the barcoded vouchers are mixed needs to be performed to total sales.

As a machine that sorts the paper sheets where the banknotes and the barcoded vouchers are mixed, for example, a machine that is disclosed in U.S. Pat. No. 7,040,476 of which an applicant is a rightful person is known. In this machine, a sensor that reads the barcoded vouchers and a recognition algorithm that recognizes barcodes, which perform a function of sorting the barcoded vouchers, are added to a machine that has a function of sorting US dollar banknotes corresponding to specific paper sheets.

However, in the machine that is originally a machine having a function of sorting specific paper sheets in normal paper sheets and abnormal paper sheets, a function of sorting non-specific paper sheets is newly added. Accordingly, a recognition algorithm for each of the paper sheets that are newly defined and added as process objects needs to be developed in order to realize the function of sorting the non-specific paper sheets. In particular, when the paper sheets that are newly added as the process objects are different for every store, a recognition algorithm needs to be individually developed in each store. As a result, when the function of sorting the non-specific paper sheets is newly added to the machine, a machine development cost increases.

### SUMMARY OF THE INVENTION

Accordingly, it is an object of the invention to decrease a machine development cost, when a function of sorting non-specific paper sheets is newly added to a machine that has a function of sorting specific paper sheets in normal paper sheets and abnormal paper sheets.

According to one aspect of the present invention, there is provided a paper sheet handling machine, comprising:

a taking-in unit that takes in paper sheets one by one;

a transport state detection unit that detects a transport state of each of the paper sheets taken in by the taking-in unit;

a transport unit that transports the paper sheets taken in by the taking-in unit;

a recognition unit that recognizes kinds of the paper sheets transported by the transport unit;

first and second stacking units that have stackers to stack the paper sheets transported by the transport unit, respectively; and

a control unit that judges abnormally transported paper sheets according to a detection result of the transport state detection unit, judges specific normal paper sheets, specific abnormal paper sheets or non-specific paper sheets according to a recognition result of the recognition unit, and controls the transport unit to transport the paper sheets judged as the specific abnormal paper sheets or the non-specific paper sheets to the first stacking unit and transport the paper sheets judged as the abnormally transported paper sheets or the specific normal paper sheets to the second stacking unit.

According to one aspect of the present invention, there is provided a paper sheet handling machine, comprising:

a taking-in unit that takes in paper sheets one by one;

a transport state detection unit that detects a transport state of each of the paper sheets taken in by the taking-in unit;

a transport unit that transports the paper sheets taken in by the taking-in unit;

a recognition unit that recognizes kinds of the paper sheets transported by the transport unit;

first to third stacking units that have stackers to stack the paper sheets transported by the transport unit, respectively; and

a control unit that judges abnormally transported paper sheets according to a detection result of the transport state detection unit, judges specific normal paper sheets, specific abnormal paper sheets or non-specific paper sheets according to a recognition result of the recognition unit, and controls the transport unit to transport the paper sheets judged as the specific abnormal paper sheets or the non-specific paper sheets to the first stacking unit, transport the paper sheets judged as the specific normal paper sheets to the second stacking unit, and transport the paper sheets judged as the abnormally transported paper sheets to the third stacking unit.

According to the invention, a sorting job of paper sheets where banknotes and the paper sheets other than the banknotes are mixed can be efficiently performed without causing an operator to perform a job for sorting the paper sheets other than the banknotes or adding a new sensor.

### BRIEF DESCRIPTION OF THE DRAWINGS

FIG. 1 is a front view illustrating the configuration of a paper sheet handling machine according to a first embodiment of the invention;

FIG. 2 is a block diagram illustrating a control system of the paper sheet handling machine according to the first embodiment of the invention;

FIG. 3 is a flowchart illustrating a handling procedure of the control unit 110 in the paper sheet stacking according to the first embodiment of the invention;

FIG. 4 is a flowchart illustrating a handling procedure of the control unit 110 in the judgment according to the first embodiment of the invention;

FIG. 5 is a flowchart illustrating a handling procedure of the control unit 110 in the transport control (first handling mode) according to the first embodiment of the invention;

FIG. 6 is a flowchart illustrating a handling procedure of the control unit 110 in the transport control (second handling mode) according to the first embodiment of the invention;

FIG. 7 is a flowchart illustrating a handling procedure of the control unit 110 in the transport control (second handling/batch mode) according to the first embodiment of the invention;

FIG. 8 is a flowchart illustrating a handling procedure of the control unit 110 in a transport control (second handling/sort mode) according to the first embodiment of the invention;

FIG. 9 is a view illustrating a display example of a pattern screen that is displayed on the display unit 109 according to the first embodiment of the invention;

FIG. 10 is a front view illustrating the configuration of a paper sheet handling machine according to a second embodiment of the invention;

FIG. 11 is a flowchart illustrating a handling procedure of the control unit 110 in a transport control (first handling mode) according to the second embodiment of the invention;

FIG. 12 is a flowchart illustrating a handling procedure of the control unit 110 in a transport control (second handling mode) according to the second embodiment of the invention;

FIG. 13 is a flowchart illustrating a handling procedure of the control unit 110 in a transport control (second handling/batch mode) according to the second embodiment of the invention;

FIG. 14 is a flowchart illustrating a handling procedure of the control unit 110 in a transport control (second handling/sort mode) according to the second embodiment of the invention; and

FIG. 15 is a view illustrating a display example of a pattern screen that is displayed on the display unit 209 according to the second embodiment of the invention.

### DETAILED DESCRIPTION OF THE INVENTION

Hereinafter, embodiments of the invention will be described more specifically with reference to the accompanying drawings. The following embodiments are only exemplary and do not restrict a range of the invention.

### First Embodiment

First, the first embodiment of the invention will be described.

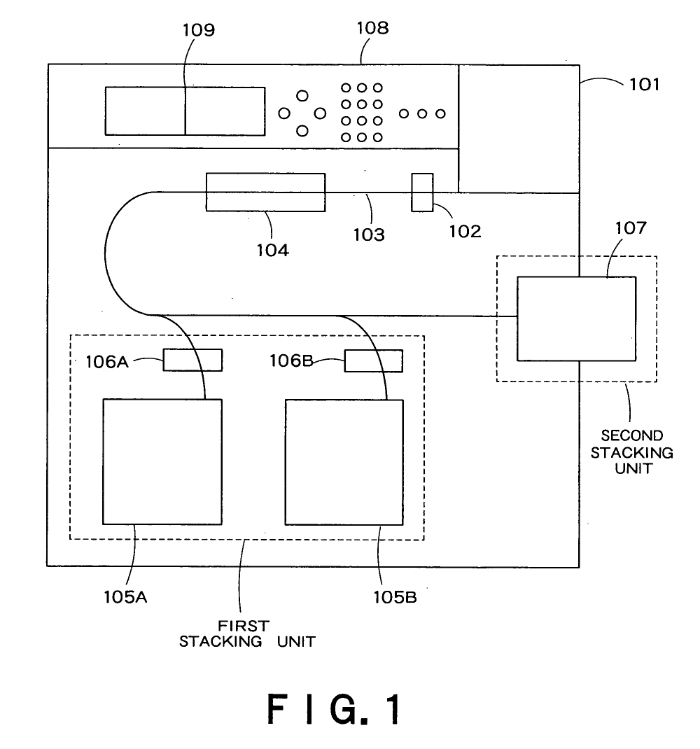

FIG. 1 is a front view illustrating the configuration of a paper sheet handling machine according to the first embodiment of the invention.

The paper sheet handling machine according to the first embodiment of the invention includes a taking-in unit 101, a transport state detection unit 102, a transport unit 103, a recognition unit 104, a first stacking unit, a second stacking unit, a designation unit 108, and a display unit 109.

The taking-in unit 101 takes in paper sheet one by one from a batch of placed paper sheets. The taking-in unit 101 operates according to a control unit 110 to be described below.

The transport state detection unit 102 is a sensor that detects a transport state of each of the paper sheets taken in by the taking-in unit 101. When the transport state detection unit 102 detects transport abnormality, the transport state detection unit 102 sends an abnormal transport signal to the control unit 110 to be described below. For example, the transport state detection unit 102 sends the abnormal transport signal to the control unit 110 in a state (skewed state) where the paper sheets are obliquely taken in by the taking-in unit 101, a state (chained state) where the paper sheets are not taken in at a predetermined interval, or a state (double-fed state) where the paper sheets are taken in while overlapping.

The transport unit 103 is a transport mechanism that is used to transport the paper sheets taken in by the taking-in unit 101 to the first stacking unit or the second stacking unit. In FIG. 1, the transport unit 103 becomes a mechanism that has a transport passage shape configured in a form of having a U shape in a horizontal direction and is formed of a mechanism including a diverter that includes plural transport belts, transport rollers, and diverter claws. The transport unit 103 operates according to the control unit 110.

The recognition unit 104 is a sensor that is used to recognize kinds of the paper sheets (denomination, authenticity, and fitness-unfitness of banknotes) transported by the transport unit 103. When the recognition unit 104 recognizes the kind of the paper sheets, the recognition unit 104 sends a recognition signal indicating a recognition result to the control unit 110. The recognition unit 104 is provided at the back of the transport state detection unit 102, but may be provided at a front stage of the transport state detection unit 102 or provided integrally with the transport state detection unit 102.

The first stacking unit has a first stacker 105A and a second stacker 105B in which the paper sheets transported by the transport unit 103 are stacked, a counter 106A that counts the paper sheets stacked in the first stacker 105A, and a counter 106B that counts the paper sheets stacked in the second stacker 105B.

The first stacker 105A and the second stacker 105B have openings that are opened in the same direction and display panels that display count results of the counters 106A and 106B, respectively.

The counters 106A and 106B count the paper sheets stacked in the first stacker 105A and the second stacker 105B and send signals indicating the count results to the display panels of the first and second stackers 105A and 105B, and the control unit 110 to be described below.

The number of stackers of the first stacking unit may be a few and the number of counters 106 may be equal to the number of stackers of the first stacking unit.

The second stacking unit has a stacker 107 in which the paper sheets transported by the transport unit 103 are stacked. The second stacking unit is provided at a position closer to the taking-in unit 101 than the first stacking unit. Preferably, the second stacking unit is provided at the end of the U-shaped transport belt, under the taking-in unit 101.

The stacker 107 has openings that are opened in plural directions including a direction facing the taking-in unit 101 and a movable stopper that prevents springing-out of the stacked paper sheets. The maximum number of stacked sheets of the stacker 107 is smaller than the maximum number of stacked sheets of each of the first stacker 105A and the second stacker 105B of the first stacking unit.

The designation unit 108 has plural instruction keys that are used to receive instructions of an operator. When the operator presses the instruction key, the designation unit 108 sends a signal indicating the pressed instruction key to the control unit 110 to be described below.

The display unit 109 includes two liquid crystal displays that display predetermined images. The display unit 109 appropriately displays image data, which is sent from the control unit 110 to be described below, on the two liquid crystal displays.

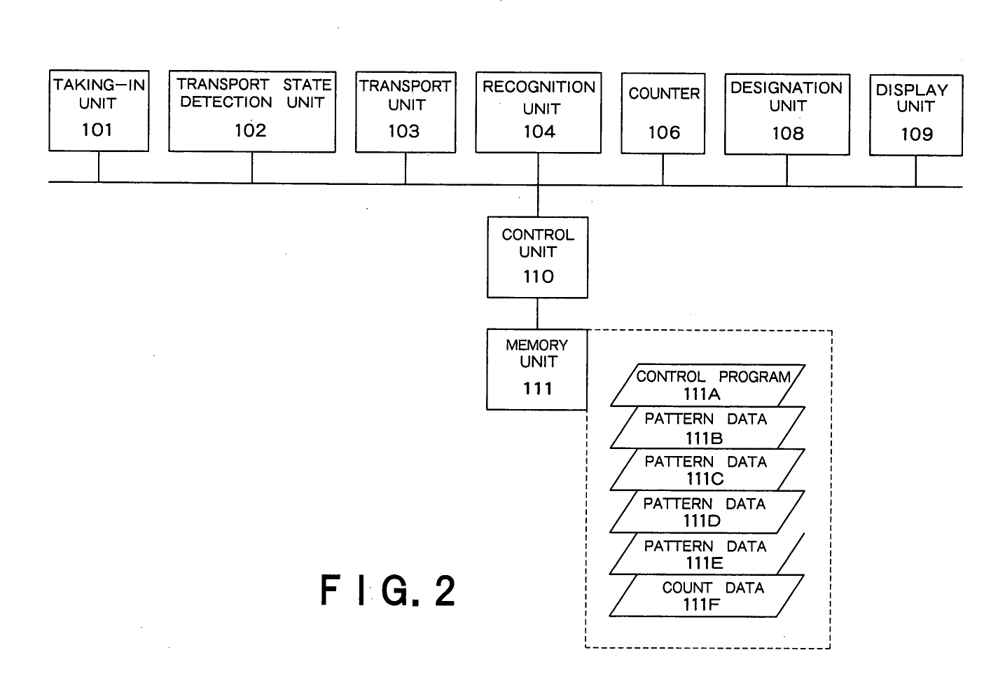

FIG. 2 is a block diagram illustrating a control system of the paper sheet handling machine according to the first embodiment of the invention.

The paper sheet handling machine according to the first embodiment of the invention includes a control unit 110 and a memory unit 111.

The control unit 110 is connected to the taking-in unit 101, the transport state detection unit 102, the transport unit 103, the recognition unit 104, the counter 106, the designation unit 108, the display unit 109, and the memory unit 111. The control unit 110 operates according to a control program 111A to be descried below. The control unit 110 sends/receives signals or data to/from the taking-in unit 101, the transport state detection unit 102, the transport unit 103, the recognition unit 104, the counter 106, the designation unit 108, and the display unit 109. The control unit 110 reads/writes data from/in the memory unit 111.

The memory unit 111 is a memory that stores the control program 111A, pattern data 111B to 111E, and count data 111F.

The control program 111A is a program module that stores the operation of the control unit 110.

The pattern data 111B to 111E include program module that stores a handling procedure of the control unit 110 for executing patterns 1 to 4 to be described below, and image data that represents the patterns 1 to 4.

The count data 111F is data that indicates count results of the counters 106A and 106B.

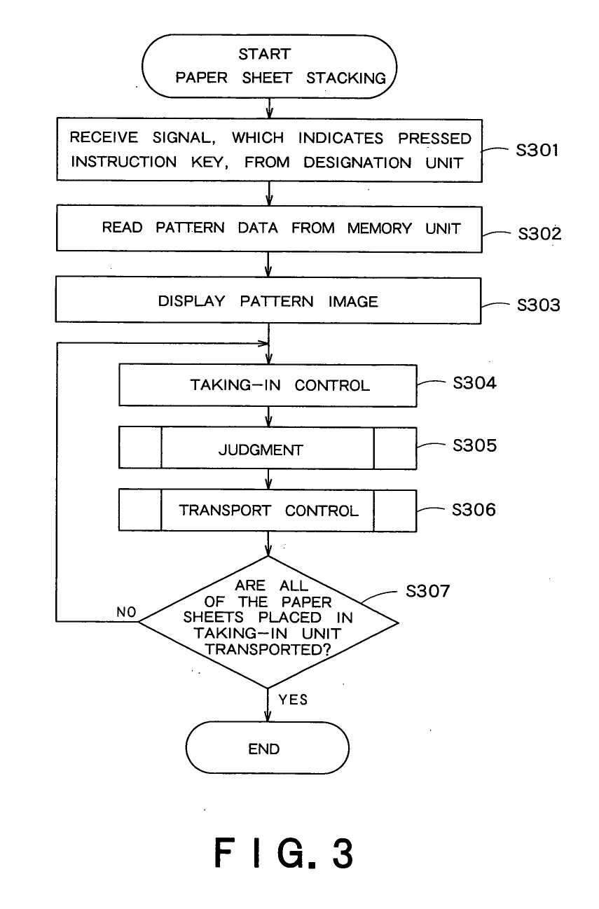

FIG. 3 is a flowchart illustrating a handling procedure of the control unit 110 in the paper sheet stacking according to the first embodiment of the invention. The paper sheet stack handling according to the first embodiment of the invention is performed according to the control program 111A.

First, the control unit 110 receives the signal that is sent from the designation unit 108 and indicates the pressed instruction key (S301).

Next, the control unit 110 reads any of the pattern data 111B to 111E from the memory unit 111 according to the signal that is received in S301 (S302).

Next, the control unit 110 controls the display unit 109 to display a pattern image according to any image data of the pattern data 111B to 111E that is read in S302 (S303).

Next, the control unit 110 controls the taking-in unit 101 to take in the placed paper sheets one by one (S304).

Next, the control unit 110 performs the following judgment according to an abnormal transport signal sent form the transport state detection unit 102 or a recognition signal sent from the recognition unit 104 (S305).

Next, the control unit 110 activates any program module of the pattern data 111B to 111E that are read in S302 and performs transport control to be described below (S306).

S304 to S306 are repeatedly performed until all of the paper sheets placed in the taking-in unit 101 are transported (NO in S307). If all of the paper sheets placed in the taking-in unit 101 are transported (YES in S307), the paper sheet stack handling according to the first embodiment of the invention is completed.

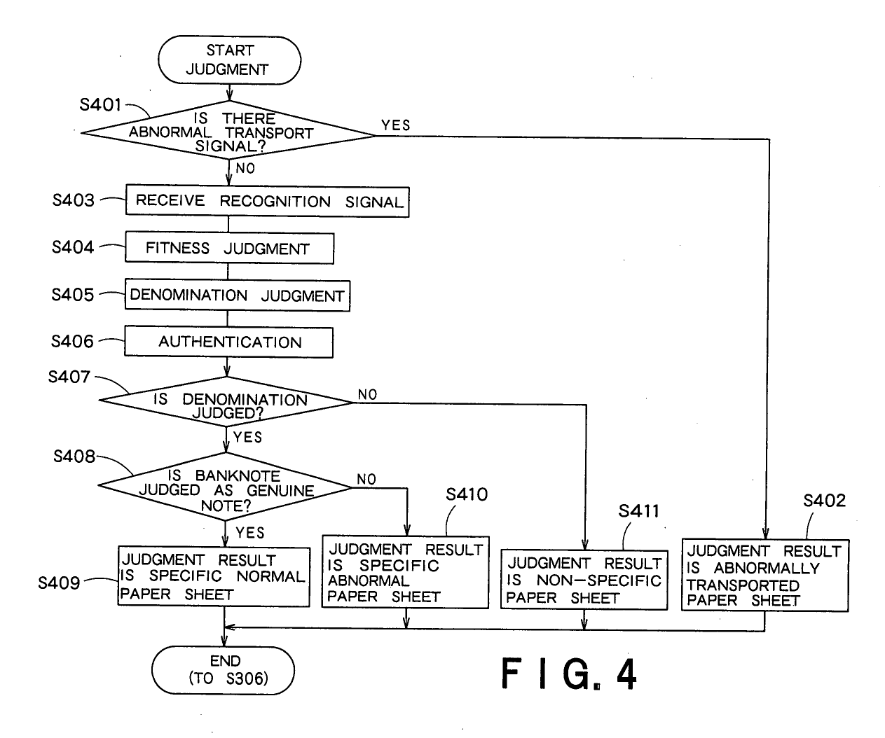

FIG. 4 is a flowchart illustrating a handling procedure of the control unit 110 in the judgment according to the first embodiment of the invention.

First, when an abnormal transport signal is sent from the transport state detection unit 102 (YES in S401), the control unit 110 determines an abnormally transported paper sheet as the judgment result (S402).

Meanwhile, when an abnormal transport signal is not sent form the transport state detection unit 102 (NO in S401), the control unit 110 receives the recognition signal sent from the recognition unit 104 (S403).

Next, the control unit 110 performs fitness-unfitness judgment (S404) for judging whether the shape of the paper sheet has abnormality, denomination judgment (S405) for judging the denomination of a banknote, when the paper sheet is the banknote, and authentication (S406) for judging whether the banknote is a genuine note, when the paper sheet is the banknote, according to the recognition signal that is received in S403.

When the denomination is judged in S405 (YES in S407), and it is judged that the banknote is the genuine note in S406 (YES in S408), the control unit 101 determines a specific normal paper sheet as a judgment result (S409).

When the denomination is judged in S405 (YES in S407), and it is judged that the banknote is not the genuine note in S406 (NO in S408), the control unit 101 determines a specific abnormal paper sheet as a judgment result (S410).

Meanwhile, when the denomination is not judged in S405 (NO in S407), the control unit 101 determines a non-specific paper sheet as a judgment result (S411).

The control unit 110 jumps to S306 of FIG. 3, after performing any of S402 and S409 to S411.

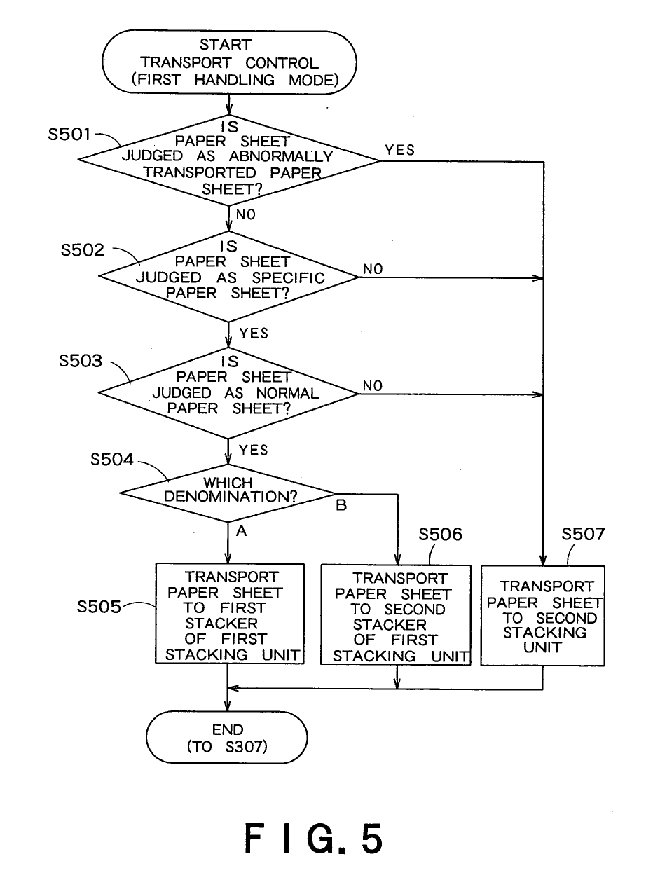

FIG. 5 is a flowchart illustrating a handling procedure of the control unit 110 in the transport control (first handling mode) according to the first embodiment of the invention. The transport control process (first handling mode) according to the first embodiment of the invention is performed according to the program module of the pattern data 111B.

First, when the paper sheet is not judged as an abnormally transported paper sheet (NO in S501) and the paper sheet is judged as a specific normal paper sheet (YES in S502 and YES in S503), the control unit 110 controls the transport unit 103 to transport a paper sheet of a denomination A to the first stacker 105A of the first stacking unit (A in S504 and S505), and controls the transport unit 103 to transport a paper sheet of a denomination B to the second stacker 105B of the first stacking unit (B in S504 and S506).

Meanwhile, when the paper sheet is judged as an abnormally transported paper sheet (YES in S501), the paper sheet is judged as a non-specific paper sheet (NO in S502) or the paper sheet is judged as a specific abnormal paper sheet (YES in S502 and NO in S503), the control unit 110 controls the transport unit 103 to transport the paper sheet judged as the abnormally transported paper sheet, the non-specific paper sheet or the specific abnormal paper sheet to the stacker 107 of the second stacking unit (S507).

The control unit 110 jumps to S307 of FIG. 3, after performing any of S505 to S507.

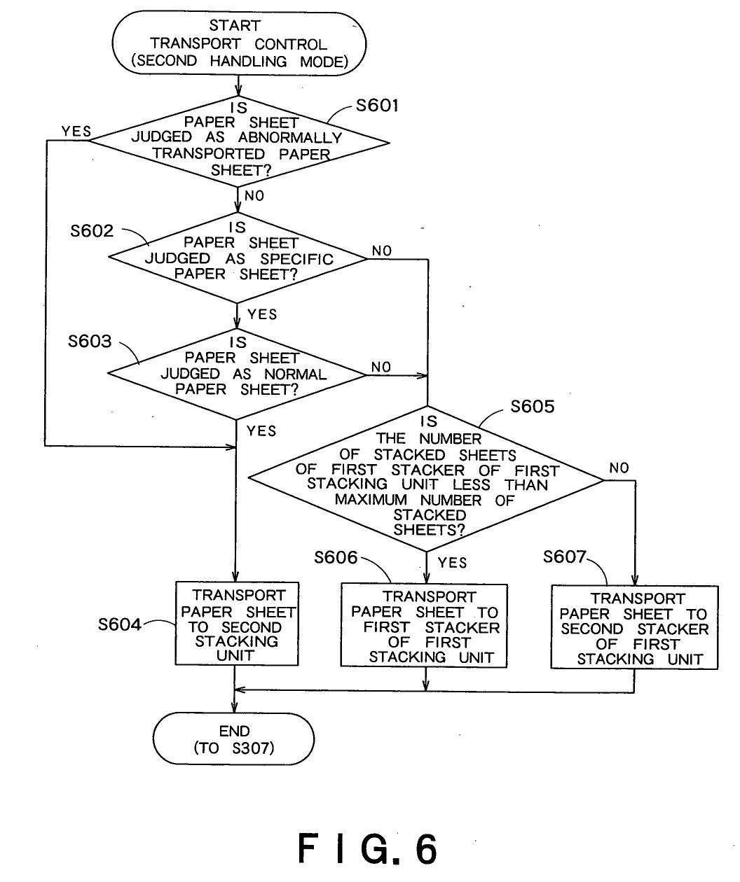

FIG. 6 is a flowchart illustrating a handling procedure of the control unit 110 in the transport control (second handling mode) according to the first embodiment of the invention. The transport control process (second handling mode) according to the first embodiment of the invention is performed according to the program module of the pattern data 111C.

First, when the paper sheet is not judged as an abnormally transported paper sheet (NO in S601) and the paper sheet is judged as a specific normal paper sheet (YES in S602 and YES in S603) or the paper sheet is judged as an abnormally transported paper sheet (YES in S601), the control unit 110 controls the transport unit 103 to transport the paper sheet judged as the specific normal paper sheet or the abnormally transported paper sheet to the stacker 107 of the second stacking unit (S604).

Meanwhile, when the paper sheet is not judged as an abnormally transported paper sheet (NO in S601) and the paper sheet is judged as a non-specific paper sheet (NO in S602) or the paper sheet is judged as a specific abnormal paper sheet (YES in S602 and NO in S603), the control unit 110 controls the transport unit 103 to transport the paper sheet judged as the non-specific paper sheet or the specific abnormal paper sheet to the first stacker 105A of the first stacking unit, until the number of stacked sheets of the first stacker 105A of the first stacking unit reaches the maximum number of stacked sheets (YES in S605 and S606). When the number of stacked sheets of the first stacker 105A of the first stacking unit reaches the maximum number of stacked sheets (NO in S605), the control unit 110 controls the transport unit 103 to transport the paper sheet judged as the non-specific paper sheet or the specific abnormal paper sheet to the second stacker 105B of the first stacking unit (S607).

The control unit 110 jumps to S307 of FIG. 3, after performing any of S604, S606, and S607.

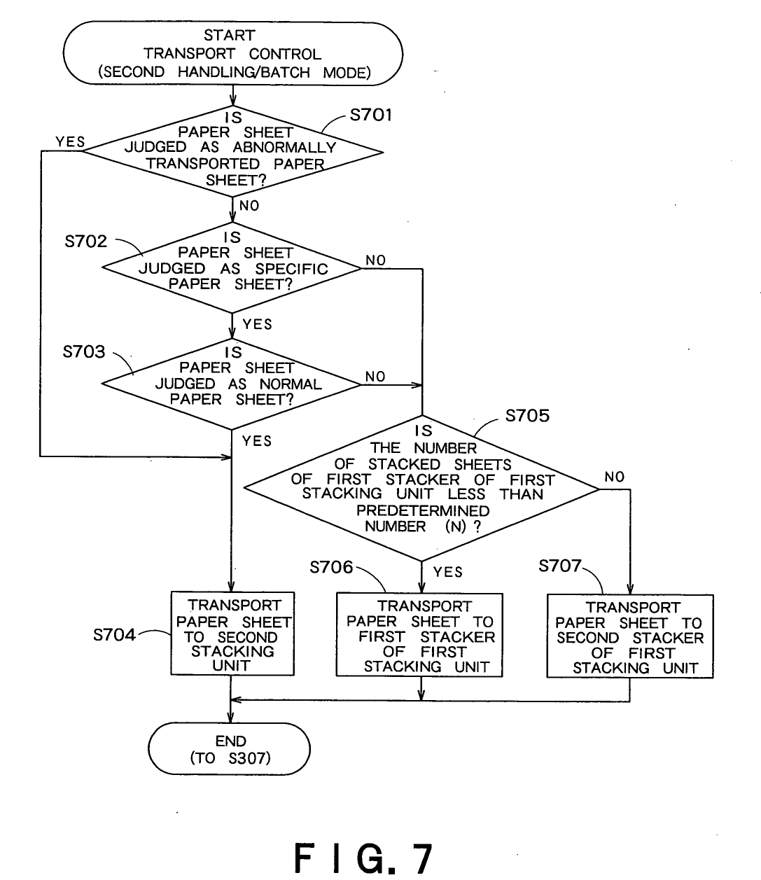

FIG. 7 is a flowchart illustrating a handling procedure of the control unit 110 in the transport control (second handling/batch mode) according to the first embodiment of the invention. The transport control (second handling/batch mode) according to the first embodiment of the invention is performed according to the program module of the pattern data 111D. The pattern data 111D includes the predetermined number (N) of sheets that is previously designated by the designation unit 108.

First, when the paper sheet is not judged as an abnormally transported paper sheet (NO in S701) and the paper sheet is judged as a specific normal paper sheet (YES in S702 and YES in S703) or the paper sheet is judged as an abnormally transported paper sheet (YES in S701), the control unit 110 controls the transport unit 103 to transport the paper sheet judged as the specific normal paper sheet or the abnormally transported paper sheet to the stacker 107 of the second stacking unit (S704).

Meanwhile, when the paper sheet is not judged as an abnormally transported paper sheet (NO in S701) and the paper sheet is judged as the non-specific paper sheet (NO in S702) or the paper sheet is judged as the specific abnormal paper sheet (YES in S702 and NO in S703), the control unit 110 controls the transport unit 103 to transport the paper sheet judged as the non-specific paper sheet or the specific abnormal paper sheet to the first stacker 105A of the first stacking unit, until the number of stacked sheets of the first stacker 105A of the first stacking unit reaches the predetermined number (N) of sheets (YES in S705 and S706). When the number of stacked sheets of the first stacker 105A of the first stacking unit reaches the predetermined number (N) of sheets (NO in S705), the control unit 110 controls the transport unit 103 to transport the paper sheet judged as the non-specific paper sheet or the specific abnormal paper sheet to the second stacker 105B of the first stacking unit (S707).

The control unit 110 jumps to S307 of FIG. 3, after performing any of S704, S706, and S707.

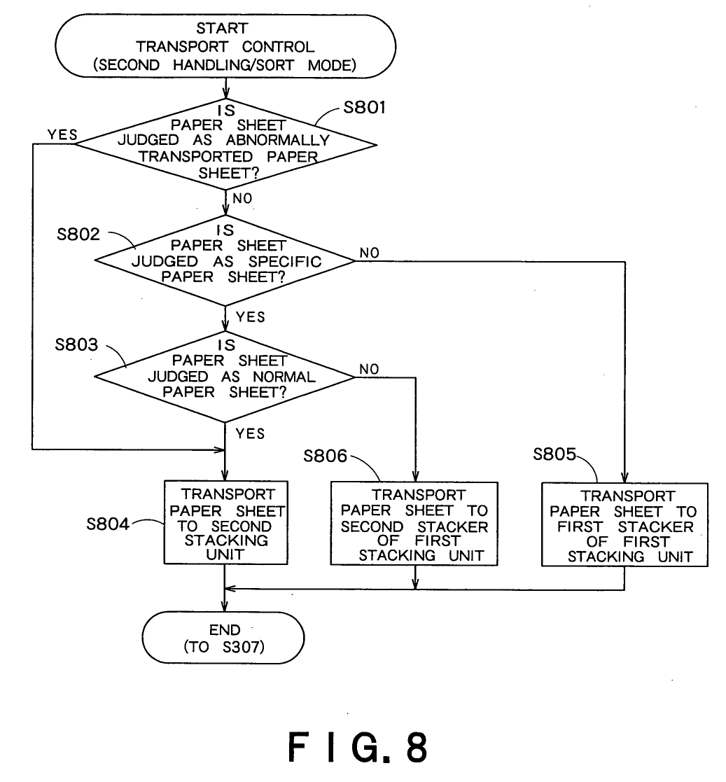

FIG. 8 is a flowchart illustrating a handling procedure of the control unit 110 in a transport control (second handling/sort mode) according to the first embodiment of the invention. The transport control (second handling/sort mode) according to the first embodiment of the invention is performed according to the program module of the pattern data 111E.

First, when the paper sheet is not judged as an abnormally transported paper sheet (NO in S801) and the paper sheet is judged as the specific normal paper sheet (YES in S802 and YES in S803) or the paper sheet is judged as an abnormally transported paper sheet (YES in S801), the control unit 110 controls the transport unit 103 to transport the paper sheet judged as the specific normal paper sheet or the abnormally transported paper sheet to the stacker 107 of the second stacking unit (S804).

Meanwhile, when the paper sheet is not judged as an abnormally transported paper sheet (NO in S801) and the paper sheet is judged as a non-specific paper sheet (NO in S802), the control unit 110 controls the transport unit 103 to transport the paper sheet judged as the non-specific paper sheet to the first stacker 105A of the first stacking unit (S805).

Meanwhile, when the paper sheet is not judged as an abnormally transported paper sheet (NO in S801) and the paper sheet is judged as a specific abnormal paper sheet (YES in S802 and NO in S803), the control unit 110 controls the transport unit 103 to transport the paper sheet judged as the specific abnormal paper sheet to the second stacker 105B of the first stacking unit (S806).

The control unit 110 jumps to S307 of FIG. 3, after performing any of S804 to S806.

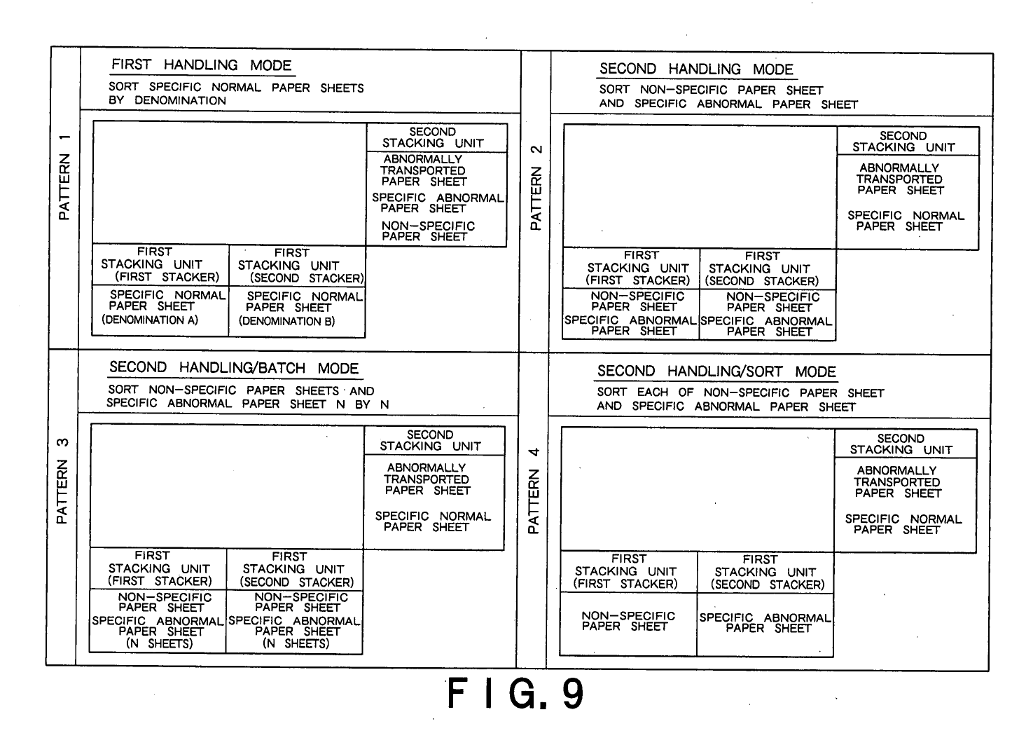

FIG. 9 schematically illustrates a display example of a pattern screen that is displayed on the display unit 109 according to the first embodiment of the invention.

The display unit 109 according to the first embodiment of the invention displays a pattern image of the pattern 1 on the liquid crystal display when the image data included in the pattern data 111B is sent in S303 of FIG. 3. The pattern 1 is a pattern that performs the first handling mode to sort the specific normal paper sheets by denomination.

The display unit 109 according to the first embodiment of the invention displays a pattern image of the pattern 2 on the liquid crystal display when the image data included in the pattern data 111C is sent in S303 of FIG. 3. The pattern 2 is a pattern that performs the second handling mode to sort the non-specific paper sheet and the specific abnormal paper sheet.

The display unit 109 according to the first embodiment of the invention displays a pattern image of the pattern 3 on the liquid crystal display when the image data included in the pattern data 111D is sent in S303 of FIG. 3. The pattern 3 is a pattern that performs the second handling/batch mode to sort the non-specific paper sheet and the specific abnormal paper sheet N by N.

The display unit 109 according to the first embodiment of the invention displays a pattern image of the pattern 4 on the liquid crystal display when the image data included in the pattern data 111E is sent in S303 of FIG. 3. The pattern 4 is a pattern that performs the second handling/sort mode to sort each of the non-specific paper sheet and the specific abnormal paper sheet.

According to the first embodiment of the invention, since only the non-specific paper sheets or the specific abnormal paper sheets are stacked in the first stacking unit, a sorting job of the paper sheets where the specific paper sheets and the non-specific paper sheets are mixed can be efficiently performed, without causing the operator to perform a job for sorting the non-specific paper sheets or adding a new recognition function.

In particular, according to the first embodiment of the invention, since the specific abnormal paper sheet is scarce, only the non-specific paper sheets can be substantially stacked in the first stacking unit.

According to the first embodiment of the invention, a sorting job of the non-specific paper sheets can be efficiently performed through the second handling/batch mode where the non-specific paper sheets and the specific abnormal paper sheets are sorted for every predetermined number of sheets or the second handling/sort mode where the non-specific paper sheets and the specific abnormal paper sheets are sorted.

According to the first embodiment of the invention, since the paper sheet handling machine receives the designation of the first handling mode where the specific normal paper sheets are sorted, the second handling mode where the non-specific paper sheets are sorted, the second handling/batch mode, or the second handling/sort mode, the paper sheet handling machine can efficiently perform a sorting job of the paper sheets according to an object.

According to the first embodiment of the invention, since the pattern image is displayed on the display unit 109, the operation to designate the handling mode can be simplified.

### Second Embodiment

Next, a second embodiment of the invention will be described. In the first embodiment of the invention, the non-specific paper sheets and the specific abnormal paper sheets are stacked to be separated from the specific normal paper sheets and the abnormally transported paper sheets. However, in the second embodiment of the invention, the non-specific paper sheets, the specific abnormal paper sheets, and the specific normal paper sheets are stacked to be separated from the abnormally transported paper sheets. The same contents as those in the first embodiment of the invention are not described.

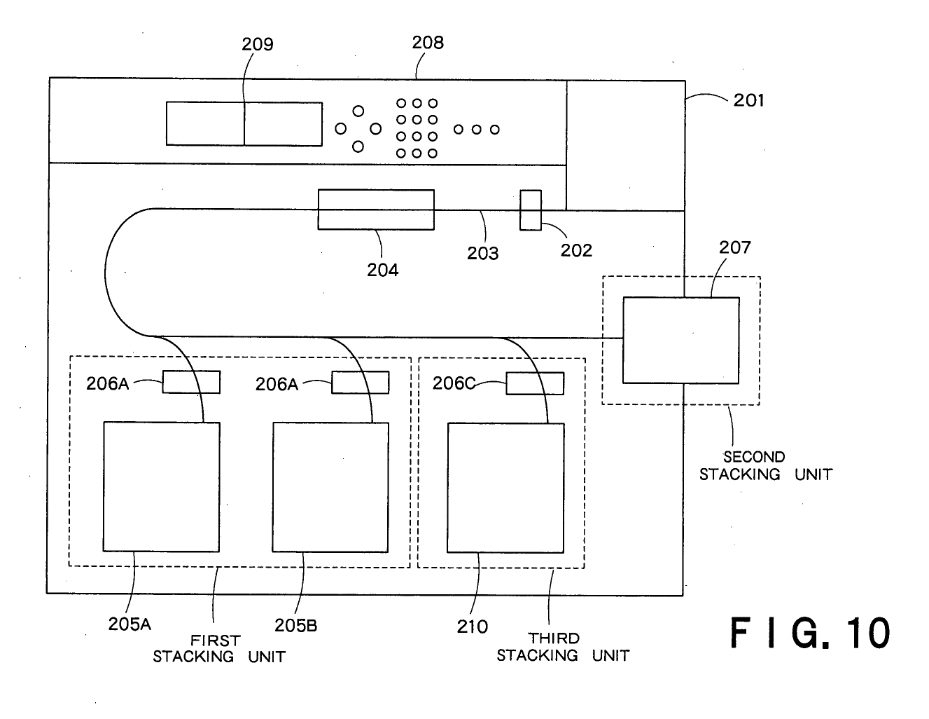

FIG. 10 is a front view illustrating the configuration of a paper sheet handling machine according to the second embodiment of the invention.

The paper sheet handling machine according to the second embodiment of the invention includes a taking-in unit 201, a transport state detection unit 202, a transport unit 203, a recognition unit 204, a first stacking unit, a second stacking unit, a third stacking unit, a designation unit 208, a display unit 209, and a control unit 110 and a memory unit 111 that are not illustrated in the same way as the first embodiment of the invention.

The taking-in unit 201 takes in paper sheets one by one from a batch of placed paper sheets. The taking-in unit 201 operates according to the control unit 110.

The transport state detection unit 202 is a sensor that detects a transport state of each of the paper sheets taken in by the taking-in unit 201. When the transport state detection unit 202 detects transport abnormality, the transport state detection unit 202 sends an abnormal transport signal to the control unit 110. For example, the transport state detection unit 202 sends the abnormal transport signal to the control unit 110 in a state (skewed state) where the paper sheets are obliquely taken in by the taking-in unit 201, a state (chained state) where the paper sheets are not taken in at a predetermined interval, or a state (double-fed state) where the paper sheets are taken in while overlapping.

The transport unit 203 is a transport mechanism that has U-shaped transport belts and diverter rollers to transport the paper sheets taken in by the taking-in unit 201 to the first stacking unit, the second stacking unit or the third stacking unit. The transport unit 203 operates according to the control unit 110.

The recognition unit 204 is a sensor that is used to recognize kinds of the paper sheets (denomination, authenticity, and fitness-unfitness of banknotes) transported by the transport unit 203. When the recognition unit 204 recognizes the kind of the paper sheets, the recognition unit 204 sends a recognition signal indicating a recognition result to the control unit 110. The recognition unit 204 is provided at the back of the transport state detection unit 202, but may be provided in front of the transport state detection unit 202 or provided integrally with the transport state detection unit 202.

The first stacking unit has a first stacker 205A and a second stacker 205B in which the paper sheets transported by the transport unit 203 are stacked, a counter 206A that counts the paper sheets stacked in the first stacker 205A, and a counter 206B that counts the paper sheets stacked in the second stacker 205B.

The first stacker 205A and the second stacker 205B have openings that are opened in the same direction and display panels that display count results of the counters 206A and 206B, respectively.

The counters 206A and 206B count the paper sheets that are stacked in the first stacker 205A and the second stacker 205B and send signals indicating the count results to the control unit 110 and the display panels of the first and second stackers 205A and 205B, respectively.

The second stacking unit has a stacker 207 in which the paper sheets transported by the transport unit 203 are stacked. The second stacking unit is provided at a position closer to the taking-in unit 201 than the first stacking unit and the third stacking unit. Preferably, the second stacking unit is provided at the end of the U-shaped transport belt, under the taking-in unit 201.

The stacker 207 has openings that are opened in plural directions including a direction facing the taking-in unit 201 and a movable stopper that prevents springing-out of the stacked paper sheets. The maximum number of stacked sheets of the stacker 207 is smaller than those of the first stacker 205A and the second stacker 205B of the first stacking unit and a stacker 210 of the third stacking unit to be described in detail below.

The designation unit 208 has plural instruction keys that are used to receive instructions of an operator. When the operator presses the instruction key, the designation unit 208 sends a signal indicating the pressed instruction key to the control unit 110.

The display unit 209 includes two liquid crystal displays that display predetermined images. The display unit 209 appropriately displays image data, which is sent from the control unit 110, on the two liquid crystal displays.

The third stacking unit has the stacker 210 in which the paper sheets transported by the transport unit 203 are stacked and a counter 206C that counts the paper sheets stacked in the stacker 210.

The stacker 210 has openings that are opened in the same directions as the first stacker 205A and the second stacker 205B and a display panel that displays a count result of the counter 206C.

The counter 206C counts the paper sheets that are stacked in the stacker 210, and sends a signal indicating a count result to the control unit 110 and the display panel of the stacker 210.

The number of stackers of each of the first stacking unit and the third stacking unit may be a few and the number of counters 206 may be equal to the number of stackers of each of the first stacking unit and the third stacking unit.

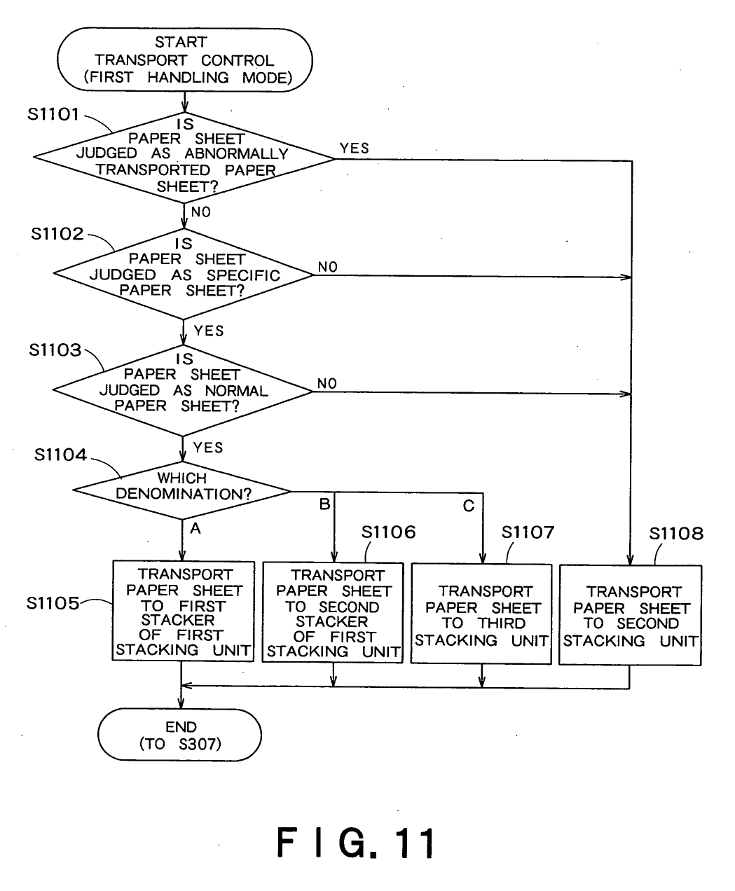

FIG. 11 is a flowchart illustrating a handling procedure of the control unit 110 in a transport control (first handling mode) according to the second embodiment of the invention. The transport control (first handling mode) according to the second embodiment of the invention is performed according to a program module of the pattern data 111B.

First, when the paper sheet is not judged as an abnormally transported paper sheet (NO in S1101) and the paper sheet is judged as a specific normal paper sheet (YES in S1102 and YES in 1103), the control unit 110 controls the transport unit 203 to transport a paper sheet of a denomination A to the first stacker 205A of the first stacking unit (A in S1104 and S1105), controls the transport unit 203 to transport a paper sheet of a denomination B to the second stacker 205B of the first stacking unit (B in S1104 and S1106), and controls the transport unit 203 to transport a paper sheet of a denomination C to the stacker 210 of the third stacking unit (C in S1104 and S1107).

Meanwhile, when the paper sheet is judged as an abnormally transported paper sheet (YES in S1101), the paper sheet is judged as a non-specific paper sheet (NO in S1102) or the paper sheet is judged as a specific abnormal paper sheet (NO in S1103), the control unit 110 controls the transport unit 203 to transport the paper sheet judged as the abnormally transported paper sheet, the non-specific paper sheet or the specific abnormal paper sheet to the stacker 207 of the second stacking unit (S1108).

The control unit 110 jumps to S307 of FIG. 3, after performing any of S1105 to S1108.

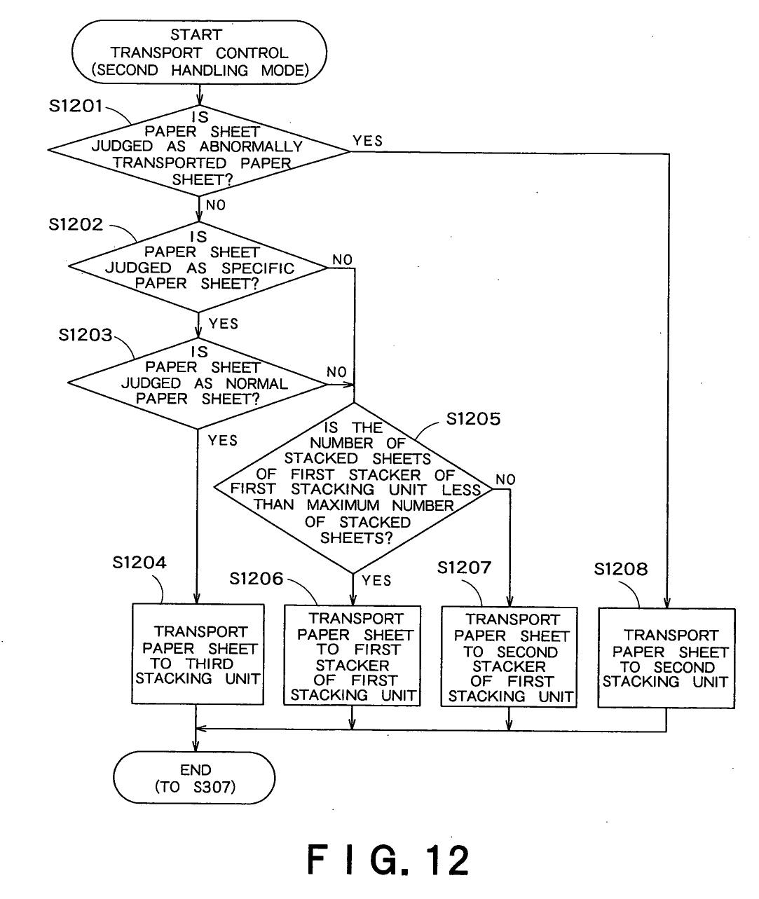

FIG. 12 is a flowchart illustrating a handling procedure of the control unit 110 in a transport control (second handling mode) according to the second embodiment of the invention. The transport control (second handling mode) according to the second embodiment of the invention is performed according to a program module of the pattern data 111C.

First, when the paper sheet is not judged as an abnormally transported paper sheet (NO in S1201) and the paper sheet is judged as a specific normal paper sheet (YES in S1202 and YES in S1203), the control unit 110 controls the transport unit 203 to transport the paper sheet judged as the specific normal paper sheet to the stacker 210 of the third stacking unit (S1204).

Meanwhile, when the paper sheet is not judged as an abnormally transported paper sheet (NO in S1201) and the paper sheet is judged as a non-specific paper sheet (NO in S1202) or the paper sheet is judged as a specific abnormal paper sheet (YES in S1202 and NO in S1203), the control unit 110 controls the transport unit 203 to transport the paper sheet judged as the non-specific paper sheet or the specific abnormal paper sheet to the first stacker 205A of the first stacking unit, until the number of stacked sheets of the first stacker 205A of the first stacking unit reaches the maximum number of stacked sheets (YES in S1205 and S1206). When the number of stacked sheets of the first stacker 205A of the first stacking unit reaches the maximum number of stacked sheets (NO in S1205), the control unit 110 controls the transport unit 203 to transport the paper sheet judged as the non-specific paper sheet or the specific abnormal paper sheet to the second stacker 2056 of the first stacking unit (S1207).

Meanwhile, when the paper sheet is judged as an abnormally transported paper sheet (YES in S1201), the control unit 110 controls the transport unit 203 to transport the paper sheet judged as the abnormally transported paper sheet to the stacker 207 of the second stacking unit (S1208).

The control unit 110 jumps to S307 of FIG. 3, after performing any of S1204 and S1206 to S1208.

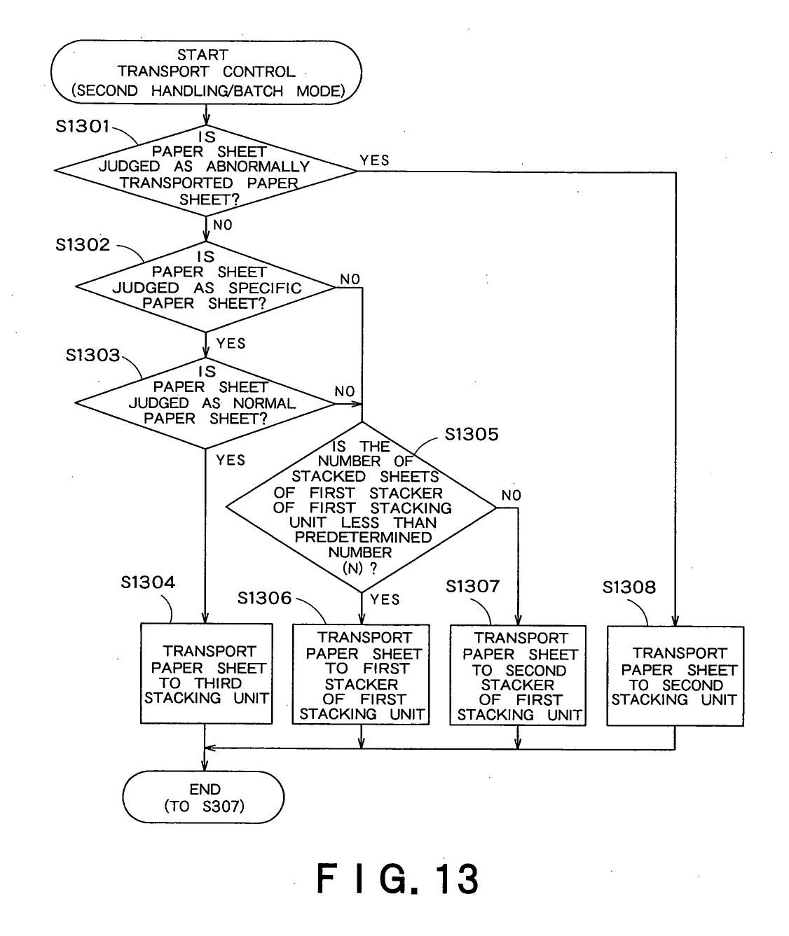

FIG. 13 is a flowchart illustrating a handling procedure of the control unit 110 in a transport control (second handling/batch mode) according to the second embodiment of the invention. The transport control (second handling/batch mode) according to the second embodiment of the invention is performed according to a program module of the pattern data 111C. The pattern data 111D includes the predetermined number (N) of sheets that is previously designated by the designation unit 208.

First, when the paper sheet is not judged as an abnormally transported paper sheet (NO in S1301) and the paper sheet is judged as a specific normal paper sheet (YES in S1302 and YES in S1303), the control unit 110 controls the transport unit 203 to transport the paper sheet judged as the specific normal paper sheet to the stacker 210 of the third stacking unit (S1304).

Meanwhile, when the paper sheet is not judged as an abnormally transported paper sheet (NO in S1301) and the paper sheet is judged as a non-specific paper sheet (NO in S1302) or the paper sheet is judged as a specific abnormal paper sheet (YES in S1302 and NO in S1303), the control unit 110 controls the transport unit 203 to transport the paper sheet judged as the non-specific paper sheet or the specific abnormal paper sheet to the first stacker 205A of the first stacking unit, until the number of stacked sheets of the first stacker 205A of the first stacking unit reaches the predetermined number (N) of sheets (YES in S1305 and S1306). When the number of stacked sheets of the first stacker 205A of the first stacking unit reaches the predetermined number (N) of sheets (NO in S1305), the control unit 110 controls the transport unit 203 to transport the paper sheet judged as the non-specific paper sheet or the specific abnormal paper sheet to the second stacker 205B of the first stacking unit (S1307).

Meanwhile, when the paper sheet is judged as an abnormally transported paper sheet (YES in S1301), the control unit 110 controls the transport unit 203 to transport the paper sheet judged as the abnormally transported paper sheet to the stacker 207 of the second stacking unit (S1308).

The control unit 110 jumps to S307 of FIG. 3, after performing any of S1304 and S1306 to S1308.

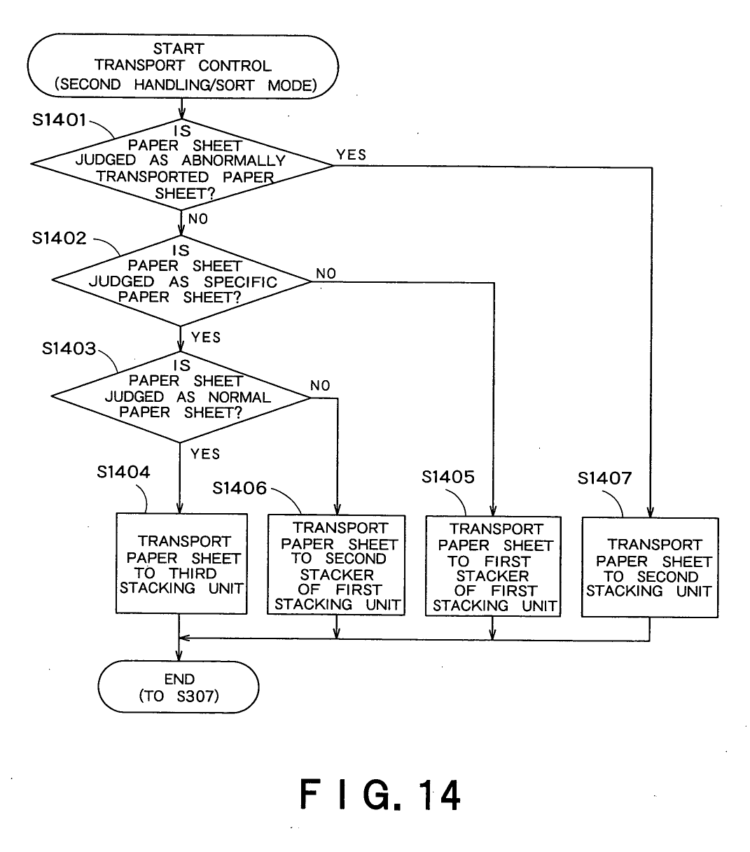

FIG. 14 is a flowchart illustrating a handling procedure of the control unit 110 in a transport control (second handling/sort mode) according to the second embodiment of the invention. The transport control (second handling/sort mode) according to the second embodiment of the invention is performed according to a program module of the pattern data 111E.

First, when the paper sheet is not judged as an abnormally transported paper sheet (NO in S1401) and the paper sheet is judged as a specific normal paper sheet (YES in S1402 and YES in S1403), the control unit 110 controls the transport unit 203 to transport the paper sheet judged as the specific normal paper sheet to the stacker 210 of the third stacking unit (S1404).

Meanwhile, when the paper sheet is not judged as an abnormally transported paper sheet (NO in S1401) and the paper sheet is judged as a non-specific paper sheet (NO in S1402), the control unit 110 controls the transport unit 203 to transport the paper sheet judged as the non-specific paper sheet to the first stacker 205A of the first stacking unit (S1405).

Meanwhile, when the paper sheet is not judged as an abnormally transported paper sheet (NO in S1401) and the paper sheet is judged as a specific abnormal paper sheet (YES in S1402 and NO in S1403), the control unit 110 controls the transport unit 203 to transport the paper sheet judged as the specific abnormal paper sheet to the second stacker 205B of the first stacking unit (S1405).

Meanwhile, when the paper sheet is judged as an abnormally transported paper sheet (YES in S1401), the control unit 110 controls the transport unit 203 to transport the paper sheet judged as the abnormally transported paper sheet to the stacker 207 of the second stacking unit (S1407).

The control unit 110 jumps to S307 of FIG. 3, after performing any of S1404 to S1407.

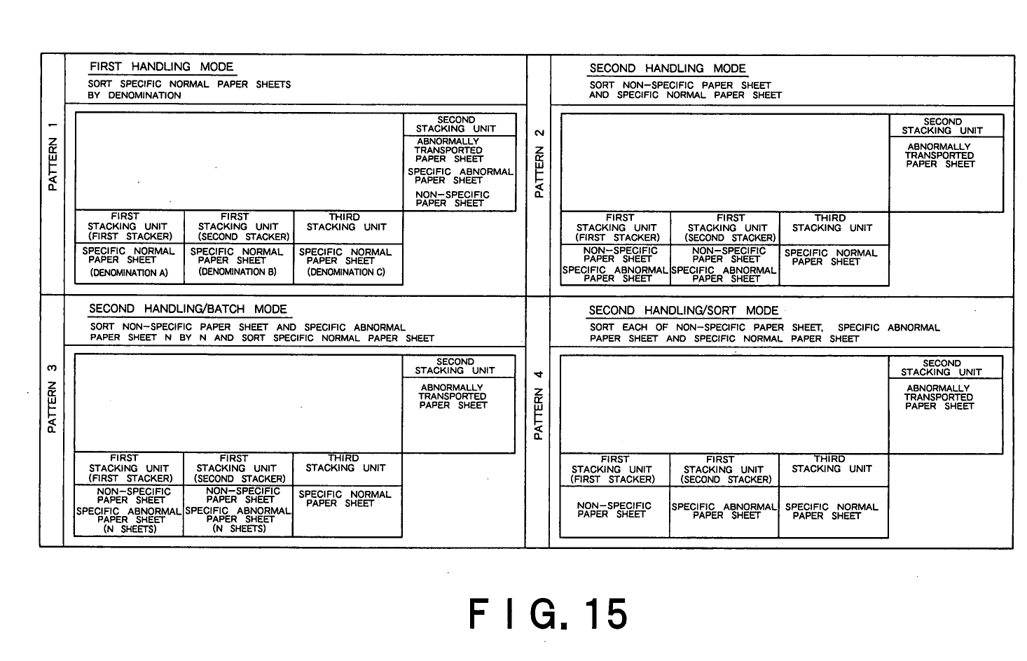

FIG. 15 schematically illustrates a display example of a pattern screen that is displayed on the display unit 209 according to the second embodiment of the invention.

The display unit 209 according to the second embodiment of the invention displays a pattern image of the pattern 1 on the liquid crystal display when the image data included in the pattern data 111B is sent in S303 of FIG. 3. The pattern 1 is a pattern that performs the first handling mode to sort the specific normal paper sheets by denomination.

The display unit 209 according to the second embodiment of the invention displays a pattern image of the pattern 2 on the liquid crystal display when the image data included in the pattern data 111C is sent in S303 of FIG. 3. The pattern 2 is a pattern that performs the second handling mode to sort the non-specific paper sheet, the specific abnormal paper sheet, and the specific normal paper sheet.

The display unit 209 according to the second embodiment of the invention displays a pattern image of the pattern 3 on the liquid crystal display when the image data included in the pattern data 111D is sent in S303 of FIG. 3. The pattern 3 is a pattern that performs the second handling/batch mode to sort the non-specific paper sheet and the specific abnormal paper sheet N by N and sort the specific normal paper sheet.

The display unit 209 according to the second embodiment of the invention displays a pattern image of the pattern 4 on the liquid crystal display when the image data included in the pattern data 111E is sent in S303 of FIG. 3. The pattern 4 is a pattern that performs the second handling/sort mode to sort each of the non-specific paper sheet, the specific abnormal paper sheet, and the specific normal paper sheet.

According to the second embodiment of the invention, in addition to the same effect as the first embodiment of the invention, only the non-specific paper sheets or the specific abnormal paper sheets are stacked in the first stacking unit, and the specific normal paper sheets are stacked in the third stacking unit. Therefore, a sorting job of the paper sheets where the specific paper sheets and the non-specific paper sheets are mixed can be more efficiently performed than the first embodiment of the invention, without causing the operator to perform a job for sorting the non-specific paper sheets, the specific normal paper sheets, and the specific abnormal paper sheets or adding a new recognition function.

1. A paper sheet handling machine, comprising:
a taking-in unit that takes in paper sheets one by one;
a transport state detection unit that detects a transport state of each of the paper sheets taken in by the taking-in unit;
a transport unit that transports the paper sheets taken in by the taking-in unit;
a recognition unit that recognizes kinds of the paper sheets transported by the transport unit;
first and second stacking units that have stackers to stack the paper sheets transported by the transport unit, respectively; and
a control unit that judges abnormally transported paper sheets according to a detection result of the transport state detection unit, judges specific normal paper sheets, specific abnormal paper sheets or non-specific paper sheets according to a recognition result of the recognition unit, and controls the transport unit to transport the paper sheets judged as the specific abnormal paper sheets or the non-specific paper sheets to the first stacking unit and transport the paper sheets judged as the abnormally transported paper sheets or the specific normal paper sheets to the second stacking unit.

2. The paper sheet handling machine according to claim 1,
wherein the recognition unit recognizes the denomination and authenticity of banknotes, and
the control unit judges the paper sheets, which are recognized as genuine notes of a predetermined denomination by the recognition unit, as the specific normal paper sheets, judges the paper sheets, which are recognized as the paper sheets of a predetermined denomination but are not recognized as the genuine notes, as the specific abnormal paper sheets, and judges the paper sheets, which are not recognized as the paper sheets of a predetermined denomination, as the non-specific paper sheets.

3. The paper sheet handling machine according to claim 1,
wherein the first stacking unit has a plurality of stackers that include counters to count the stacked paper sheets, and
the control unit controls the transport unit to transport the paper sheets judged as the specific abnormal paper sheets or the non-specific paper sheets to one of the plurality of stackers, and controls the transport unit to transport the paper sheets judged as the specific abnormal paper sheets or the non-specific paper sheets to the other of the plurality of stackers, when the number of paper sheets counted by the counter included in the one of the plurality of stackers reaches a predetermined number of sheets.

4. The paper sheet handling machine according to claim 1,
wherein the first stacking unit has a plurality of stackers, and
the control unit controls the transport unit to transport the paper sheets judged as the specific abnormal paper sheets to one of the stackers and transport the paper sheets judged as the non-specific paper sheets to the other of the stackers.

5. The paper sheet handling machine according to claim 1, further comprising:
a designation unit that designates handling modes indicating sort patterns of the paper sheets stacked in the first and second stacking unit,
wherein the control unit controls the transport unit to transport the paper sheets judged as the specific normal paper sheets to the first stacking unit and transport the paper sheets judged as the abnormally transported paper sheets, the specific abnormal paper sheets or the non-specific paper sheets to the second stacking unit, when a first handling mode is designated by the designation unit, and controls the transport unit to transport the paper sheets judged as the specific abnormal paper sheets or the non-specific paper sheets to the first stacking unit and transport the paper sheets judged as the abnormally transported paper sheets or the specific normal paper sheets to the second stacking unit, when a second handling mode is designated by the designation unit.

6. The paper sheet handling machine according to claim 5, further comprising:
a memory unit that stores the sort patterns,
wherein the designation unit designates the sort patterns that are stored in the memory unit, and
the control unit controls the transport unit according to the sort patterns that are designated by the designation unit.

7. The paper sheet handling machine according to claim 1,
wherein the number of paper sheets, which the stacker of the second stacking unit is capable of stacking, is smaller than the number of paper sheets which the stacker of the first stacking unit is capable of stacking.

8. A paper sheet handling machine, comprising:
a taking-in unit that takes in paper sheets one by one;
a transport state detection unit that detects a transport state of each of the paper sheets taken in by the taking-in unit;
a transport unit that transports the paper sheets taken in by the taking-in unit;
a recognition unit that recognizes kinds of the paper sheets transported by the transport unit;
first to third stacking units that have stackers to stack the paper sheets transported by the transport unit, respectively; and
a control unit that judges abnormally transported paper sheets according to a detection result of the transport state detection unit, judges specific normal paper sheets, specific abnormal paper sheets or non-specific paper sheets according to a recognition result of the recognition unit, and controls the transport unit to transport the paper sheets judged as the specific abnormal paper sheets or the non-specific paper sheets to the first stacking unit, transport the paper sheets judged as the specific normal paper sheets to the second stacking unit, and transport the paper sheets judged as the abnormally transported paper sheets to the third stacking unit.

9. The paper sheet handling machine according to claim 8,
wherein the recognition unit recognizes the denomination and authenticity of banknotes, and
the control unit judges the paper sheets, which are recognized as genuine notes of a predetermined denomination by the recognition unit, as the specific normal paper sheets, judges the paper sheets, which are recognized as the paper sheets of a predetermined denomination but are not recognized as the genuine notes, as the specific abnormal paper sheets, and judges the paper sheets, which are not recognized as the paper sheets of a predetermined denomination, as the non-specific paper sheets.

10. The paper sheet handling machine according to claim 8,
wherein the first stacking unit has a plurality of stackers that include counters to count the stacked paper sheets, and
the control unit controls the transport unit to transport the paper sheets judged as the specific abnormal paper sheets or the non-specific paper sheets to one of the plurality of stackers, and controls the transport unit to transport the paper sheets judged as the specific abnormal paper sheets or the non-specific paper sheets to the other of the plurality of stackers, when the number of paper sheets counted by the counter included in the one of the plurality of stackers reaches a predetermined number of sheets.

11. The paper sheet handling machine according to claim 8,
wherein the first stacking unit has a plurality of stackers, and
the control unit controls the transport unit to transport the paper sheets judged as the specific abnormal paper sheets to one of the plurality of stackers and transport the paper sheets judged as the non-specific paper sheets to the other of the plurality of stackers.

12. The paper sheet handling machine according to claim 8, further comprising:
a designation unit that designates handling modes indicating sort patterns of the paper sheets stacked in the first to third stacking units,
wherein the control unit controls the transport unit to transport the paper sheets judged as the specific normal paper sheets to the first or second stacking unit according to the kinds of the paper sheets recognized by the recognition unit and transport the paper sheets judged as the abnormally transported paper sheets, the specific abnormal paper sheets or the non-specific paper sheets to the third stacking unit, when a first handling mode is designated by the designation unit, and controls the transport unit to transport the paper sheets judged as the specific abnormal paper sheets or the non-specific paper sheets to the first stacking unit, transport the paper sheets judged as the specific normal paper sheets to the second stacking unit, and transport the paper sheets judged as the abnormally transported paper sheets to the third stacking unit, when a second handling mode is designated by the designation unit.

13. The paper sheet handling machine according to claim 12, further comprising:
a memory unit that stores the sort patterns,
wherein the designation unit designates the sort patterns that are stored in the memory unit, and
the control unit controls the transport unit according to the sort patterns that are designated by the designation unit.

14. The paper sheet handling machine according to claim 8,
wherein the number of paper sheets, which the stacker of the third stacking unit is capable of stacking, is smaller than the number of paper sheets which each stacker of the first and second stacking units is capable of stacking.
